(19) United States
(12) Patent Application Publication
(10) Pub. No.: US 2005/0080649 A1
(43) Pub. Date: Apr. 14, 2005

(54) Systems and methods for automating the capture, organization, and transmission of data

(76) Inventors: Andres C. Alvarez, Newport Beach, CA (US); Leon G. McCreary, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/961,310

(22) Filed: Oct. 8, 2004

Related U.S. Application Data
(60) Provisional application No. 60/509,579, filed on Oct. 8, 2003.
(60) Provisional application No. 60/532,171, filed on Dec. 23, 2003.

(51) Int. Cl. G06F 17/60

(52) U.S. Cl. 705/1; 705/4

(57) ABSTRACT

Systems and methods automate data entry and processing. Data is automatically entered into a system by reading a user identification card. The data can be supplemented with additional information, if necessary, and processed by the system. In one embodiment, the data is used to register an employee for an employee benefit program offered by a provider such as an insurance carrier. The data read from the identification card is automatically entered into an electronic enrollment form where the user can check it. Documentation corresponding to the enrollment form can be converted to an electronic copy, if necessary, and attached to the enrollment form. Once the enrollment form is complete, the user can electronically sign the enrollment form and send it through a computer network to the provider. The provider may then process the enrollment form, request additional information or corrections from the user, and register the user for the products or services.

### CLAIM FOR PRIORITY

This application claims priority under 35 U.S.C. § 119(e) of U.S. Provisional Application No. 60/509,579, filed Oct. 8, 2003, titled “EMPLOYEE DATA ENTRY CARD READER SOLUTIONS,” and Provisional Patent Application No. 60/532,171, filed Dec. 23, 2003, titled “METHODS FOR AUTOMATING DATA ENTRY,” both of which are hereby incorporated herein by reference in their entirety.

### BACKGROUND OF THE INVENTION

1. Field of the Invention

The invention relates generally to data management. More particularly, the invention relates to systems and methods for automating data entry and processing data to register one or more individuals for products or services offered by an insurance carrier. provider.

2. Description of the Related Art

Entering data into a computerized system can be time consuming and expensive. Manual data entry can also be the source of errors. Many organizations enter, edit, transmit, maintain and otherwise manage large amounts of data on a regular basis. For example, company human resource departments enter and maintain employee records comprising personal information about their employees.

When employee records are manually keyed into a system, there is a chance for error even if this data is checked manually to verify its accuracy. If an error is made initially and it is overlooked upon verification, the error can be perpetuated throughout the system. In a database driven system that is dependent upon user review to verify data, inaccuracy is usually not discovered until its presence directly affects company or employee related processes or functions. For example, if an employee's dependent information is entered into a company database incorrectly and this data is used to determine payroll deductions and tax calculations, the problem may not be corrected until the employee discovers the problem and brings it to the attention of human resource representatives.

Generally, human resource personnel serve multiple functions and are trained to handle employee data for purposes such as processing payroll or administrating employee benefits such as health insurance, life insurance, worker's compensation, pensions plans, or the like. Human resource personnel have used online Application Service Providers (ASPs) to help administrate and organize employee information including, for example, record organization, benefits enrollments, and other payroll or human resource related issues.

However, many organizations do not adequately manage data in an accurate or timely manner. For example, employee application forms or benefits enrollment forms are often filled out by hand and can be difficult to read. Further, such forms are often copied and may change hands several times before they are manually input into a computer system. Such multi-stage processes are subject to delays and data entry errors. In addition, some companies employ workers that speak a foreign language, making it difficult to ask them for basic employee information or enroll them in employee benefits programs.

Service providers such as insurance carriers or other providers of employee benefits programs also gather and manage employee data. Such service providers may gather employee data directly from employees, from an employer's records, or both. The collection, processing and management of employee data by a service provider can be complicated, time consuming and open to many opportunities for error.

Further, the information involved in employee benefits transactions may include an employer's valuable proprietary information, personally identifiable employee information, or both. The management, transmission, use and/or disclosure of such information may be regulated at least in part by industry standards, laws, rules, or regulations. For example, the U.S. Health Insurance Privacy and Accountability Act of 1996 (Public Law 104-191) and rules and regulations thereunder (referred to collectively herein as “HIPAA”), includes provisions for standardizing electronic data interchange and protection of confidentiality and security of health data. HIPAA requires that all healthcare organizations that maintain or transmit health information electronically establish and maintain reasonable and appropriate administrative, technical and physical safeguards to ensure the integrity, confidentiality and availability of the information. The safeguards are also designed to protect the information against reasonably anticipated threats to its security or integrity.

### SUMMARY OF THE INVENTION

The present invention relates to systems and methods for automatically entering and managing data to enroll individuals for products and services offered by a provider. According to one embodiment, a method is provided for obtaining products or services offered by a remote provider. The method includes displaying an application form in response to selection of a desired product or service, reading user data into a computer from an identification card, automatically entering the user data into appropriate data entry fields of the application form, completing the application form, and communicating the completed application form to a remote server configured to create a user account in response to receiving the application form.

In one embodiment, a system is for enrolling customers for services offered by insurance carriers includes an agent system comprising an enrollment module configured to display an enrollment form. The enrollment module is configured to populate user data into appropriate data entry fields of the enrollment form. The system also includes one or more carrier servers comprising carrier modules configured to receive the enrollment form from the enrollment module through a computer network. The system further includes a managing server comprising an interface module that coordinates communication between the enrollment module and the carrier modules. The one or more carrier servers are listed in the interface module. The enrollment module is configured to selectively send the enrollment form to the one or more carrier servers listed on the interface module.

In one embodiment, a method for enrolling customers for services offered by employee benefit providers includes providing a web page to a broker that lists employee benefit providers, providing an electronic application to the broker that comprises data entry fields for information sufficient to enroll an individual in services provided by at least one of the employee benefit providers listed on the web page, receiving a processed electronic application from the broker, and transmitting the processed electronic application to an employee benefit provider selected by the broker from the list on the web page.

In one embodiment, a method for enrolling a group of users in an employee benefit program includes generating an electronic group application, reading data from an identification card into a computer system, automatically populating the data into corresponding data entry fields in an employee application, generating a case file comprising the group application and the employee application, and sending the case file to a server through a computer network.

In one embodiment, a portable system for processing an application includes a computer and a card reader configured to read data from an identification card into the computer. The computer is configured to populate an application with the data. The portable system also includes a signature pad configured to generate an image of writing written thereon. The computer is configured to associate the image with the application. The portable system further includes a communication device configured to transmit the application to a remote server.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Systems and methods that embody the various features of the invention will now be described with reference to the following drawings, in which:

FIG. 1 is a block diagram that illustrates the relationships between some of the entities involved in employee benefits transactions;

FIG. 2A is a block diagram of a system according to an embodiment of the invention for entering and managing user data;

FIG. 2B is a block diagram of a system according to an embodiment of the invention for electronically filing an application;

FIG. 3 is a block diagram of a system according to an embodiment of the invention for registering one or more individuals for products or services offered by one or more service providers;

FIG. 4 is an exemplary flow chart illustrating portions of an enrollment process according to an embodiment of the invention;

FIG. 5 generally illustrates an example of a user interface that is usable to register individuals and groups for a product or service offered by a service provider according to an embodiment of the invention;

FIG. 6 generally illustrates an example of an electronic group form according to an embodiment of the invention;

FIG. 7 generally illustrates an example of a user interface that is usable to sign an electronic form;

FIG. 8 generally illustrates an example of a user interface for testing and controlling peripheral hardware devices;

FIG. 9 generally illustrates an example of a user interface for manually or automatically entering employee data into a system;

FIG. 10 generally illustrates an example of a user interface that is usable to search for and modify employee data; and

FIG. 11 illustrates an exemplary user interface that is usable by the employee to review, modify and sign the electronic enrollment application.

### DETAILED DESCRIPTION OF THE PREFERRED EMBODIMENT

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent components and methods to those described herein. In other instances, well-known components and methods have not been described in detail so as not to unnecessarily obscure aspects of the present invention.

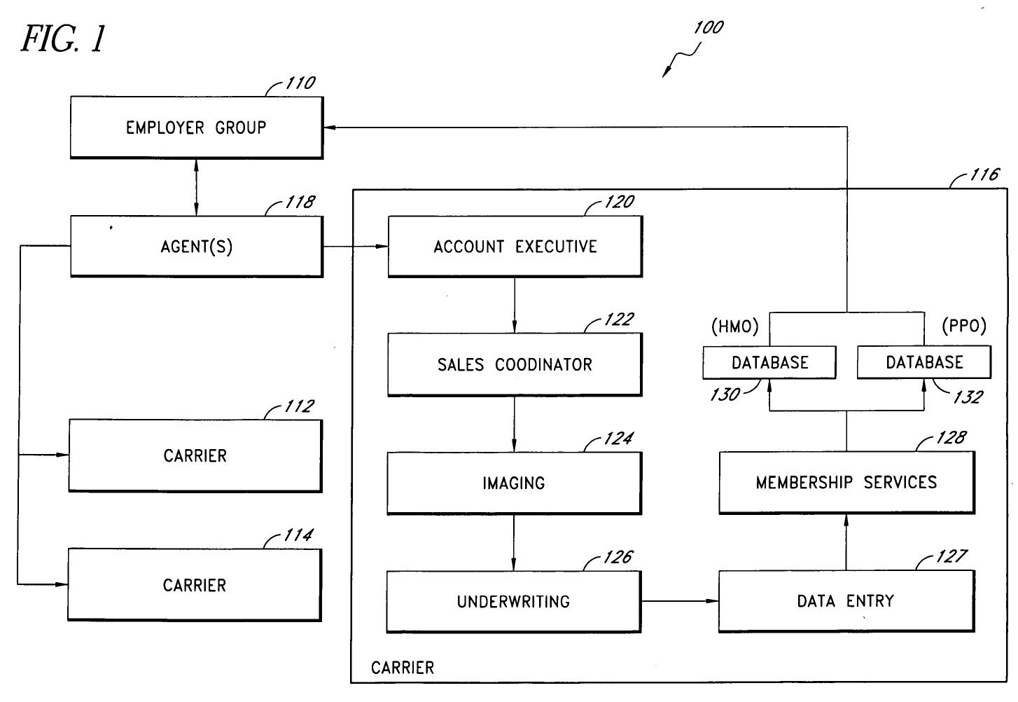

FIG. 1 is a block diagram that illustrates some of the aspects of entities 100 involved in employee benefits transactions. The entities 100 include employees in an employer group 110 who enroll in employee benefits or services provided by carriers 112, 114, 116. The carriers 112, 114, 116 may provide services such as life insurance, disability insurance, medical insurance, dental insurance, other types of health insurance, financial planning services, retirement benefit services, combinations of the forgoing, or the like.

The entities 100 also include one or more agents 118 who present and sell the employee benefits or services to a company corresponding to the employer group 110. For example, an agent 118 may sell an employee health insurance plan to the company corresponding to the employer group 110. In this example, the carrier 116 provides the health insurance plan and the agent 118 may be an independent broker or a representative of the carrier 116.

Once the agent 118 has presented and sold the plan to the company corresponding to the employer group 110, the agent 118 requests copies of documents specific to the plan from the carrier 116. The documentation may include descriptions of the plan and group enrollment forms for the employer group 110. The documentation may also include enrollment kits comprising literature describing the plan to the employees and employee enrollment forms for each participating employee in the employer group 110. Generating and shipping the enrollment kits to the agent 118 can be expensive.

The agent 118 may hold enrollment meetings at the company to describe the plan to the employees, answer employee questions, and assist in completing hard copies of the group and employee enrollment forms. The agent may also generate or receive other documents from the employer group 110 including, for example, tax forms, billing documents, other documents required by the carrier 116, industry regulation or government regulation, or the like.

Once the forms and other documents are complete, they are audited for accuracy and revised if necessary. This process may be referred to as cleaning or scrubbing the documents. Scrubbing may involve manually comparing at least a portion of the employee enrollment forms with employee records maintained by the company. The employer of the employer group 110, the agent 118, the carrier 116, or a combination of the forgoing may perform at least a portion of the scrubbing.

The completed forms and other documents are physically transported or mailed to the carrier 116 where they are received by an account executive 120 who creates and manages a new account for the plan. The account executive 120 may forward the forms and other documents to a sales coordinator department 122 where a detailed scrub of the forms and other documents are performed to ascertain any outstanding information. If anything is missing, the account is flagged and the deficient documents are returned to the agent 118 through the account executive 120 for follow up with the employer group 110.

At some point, the forms and other documents may be sent to an imaging department 124 wherein the information is manually converted to an electronic format comprising electronic images, manually keyed-in data, or both. The account is also sent to an underwriting group 126 which may participate in the scrubbing process and which may provide final approval of the account. The account is then sent to a data entry department 127 and a membership services department 128 where the information is uploaded into one or more databases 130, 132 and the plan is managed for the employer group 110.

In one embodiment of the present invention, the number of hardcopy documents exchanged by the entities 100 is reduced and a portion of the data is entered automatically. When a plan is sold to the employer, the agent 118 requests electronic copies of the plan description and enrollment kits from the carrier 116. This saves shipping and printing costs. Further, the agent 118 fills out electronic group and employee enrollment forms during enrollment meetings. Portions of the forms are filled in automatically from information acquired from the employer's system or from user I.D. cards. The user I.D. cards may comprise a driver's license, or state issued identification card. Thus, the amount of time required to conduct the enrollment meetings is reduced. Further, since the group and employee enrollment forms are in an electronic format, they can be easily scrubbed using a computer and transmitted electronically to the carrier 116.

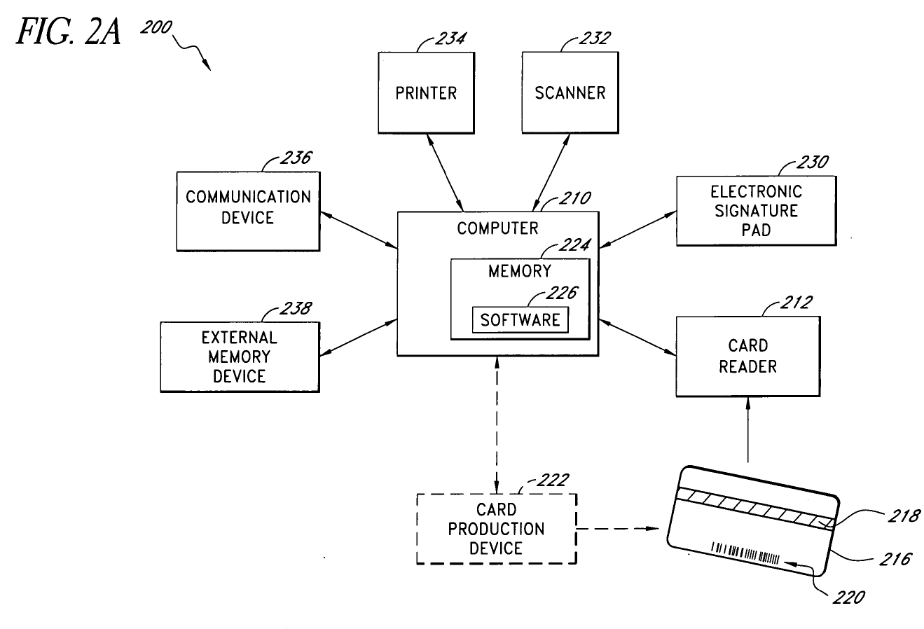

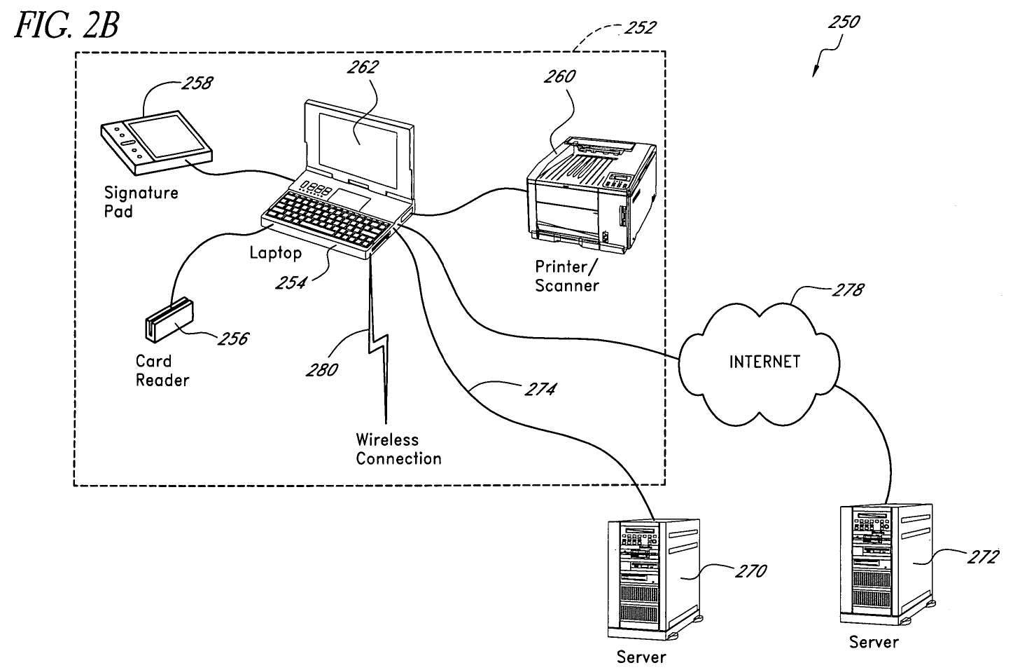

FIG. 2A is a block diagram of a system 200 for entering and managing user data. The system 200 comprises a computer 210 coupled to a card reader 212 for automatically entering user data into the computer 210. The system 200 further comprises an electronic signature pad 224, a scanner 232, a printer 234, a communication device 236 and an external memory device 238. The system may be connected to the Internet or other network through the communication device 236 and may be configured to access and store user data through an online ASP.

The card reader 212 is configured to read information from a user card 216 and to transmit the information to the computer 210. The card reader 212 may comprise, for example, a barcode reader, a magnetic stripe reader, a radio frequency identification tag reader, other automatic identification readers, combinations of the forgoing, or the like.

In one embodiment, the user card 216 comprises a driver's license or other identification card having a magnetic stripe 218, barcode 220, or both encoded with user data. In another embodiment, the user card 216 comprises a radio frequency identification tag encoded with user data. The user data comprises information sufficient to identify the user card's owner including, for example, name, address, birth date, height, weight, sex, eye color, hair color, social security number, driver's license number, electronic image of signature, digital fingerprint, combinations of the forgoing, or the like.

For example, in one embodiment the card 216 comprises an employee identification card that is encoded with employee information such as name, address, e-mail address, department, facility, employee identification number, birth date, job title, hire date, employee benefits eligibility date, tax information, and dependent information. The card 216 may also comprise other information usable to identify the employee or administrate employee benefits.

The computer 210 is a device that allows a user to interact with the card reader 212 and to manage user data. In one embodiment, the computer 210 is a conventional computer that is equipped with a conventional modem and peripheral devices such as a monitor, a keypad, a mouse, other devices that allow a user to enter data into the computer 210, combinations of the forgoing, or the like. In other embodiments, the computer 210 can be any device that allows the user to interact with the system 200, by way of example a computer workstation, a local area network of individual computers, a kiosk, a point-of-sale device, a personal digital assistant, an interactive wireless communications device, an interactive television, a transponder, or the like.

The computer includes an internal memory device 224 comprising software 226 for collecting and managing user data as described herein. In one embodiment, the internal memory device 224 comprises a hard disk drive utilizing time sensitive data encryption configured to erase data after a predetermined period of non-use. The memory 224 may also comprise, for example, stored user data. The software 226 may advantageously be configured to execute on one or more processors. The software may comprise, but is not limited to, any of the following: object-oriented software components, class components and task components, processes methods, functions, attributes, procedures, subroutines, segments of program code, drivers, firmware, microcode, circuitry, data, databases, data structures, tables, arrays, variables, or the like.

The electronic signature pad 230 is configured to generate an electronic image of writings or markings made thereon and to transmit the electronic image to the computer 210. The scanner 232 is configured to enter user data into the computer 210 that is not already in electronic form. For example, the scanner 232 can be used to record electronic images of tax documents, employee benefits forms, or the like. The printer 234 is configured to generate hard copies of the user data, forms, or other data.

The communication device 236 is configured to provide communication with external systems and devices and can comprise, for example, a serial port, a parallel port, a universal serial bus (USB) controller, or an Internet or other network adapter. The external memory device 238 may comprise, for example, drives that accept hard and floppy disks, tape cassettes, CD-ROM or DVD ROM. In one embodiment, the external memory device 238 comprises a PCMCIA card. The external memory device 238 may be configured to store user data, enrollment forms, employer data, employee benefits information, software programs, combinations of the forgoing, or the like.

The system 200 can be used, for example, to automatically generate employee data for use by a human resource department, a provider of employee benefits, or both. For example, the system 200 can be used during an interview of a potential new employee to quickly and accurately collect personal identification information from the potential new employee. As part of the interview process, the potential new employee can swipe an identification card 216 such as a driver's license or other government issued or standardized identification card through the card reader 212. Information stored on the identification card 216 is automatically read into an internal memory of the computer 210 and can be checked by an interviewer or the potential new employee for accuracy.

The information may include, for example, name, birth date, gender and resident address. Other information may also be accessed through a driver's license or the like including, for example, height, weight, eye color, hair color, social security number, driver's license number, electronic signature image, digital fingerprint, other identifying information, or the like. The interviewer can then manually enter any additional identification or personal information about the potential new employee into the computer 210. The additional information may include for example, a social security number, tax information, information regarding any dependents of the potential new employee, entry-level salary, and preference of insurance program selections.

The system 200 can also be used to access or update existing employee information. For example, manager or human resource personnel can access and modify existing personnel files by swiping a driver's license or employee identification card to identify the records of a particular employee that can then be modified. In some embodiments, the manager or human resource personnel can access and modify employee data remotely through, for example, an online ASP. Changes to the employee data can be confirmed by the manager, human resource personnel, employee, or a combination of the forgoing with an electronic signature entered into the system 200 through the electronic signature pad 230.

The system 200 can also be used to enroll employees in one or more employee benefit programs. For example, a broker or agent of an insurance carrier can transport the system 200 to a client's site to enroll the client's employees in insurance plans. Thus, in one embodiment, the system 200 is lightweight and portable. For example, the computer may comprise a laptop computer or personal digital assistant (PDA). The broker or agent can swipe the employees' driver's licenses or employee identification cards to automatically enter employee data into the system 200 or to identify previously existing employee records. Additional information may be keyed-in manually if needed. In addition, the scanner 232 can record electronic images of other documents such as enrollment forms, tax forms, or the like used in enrolling the employees. The employee applications can be completed and checked electronically at the client's site and signed electronically through the electronic signature pad 230 by the broker or agent, the individual employees, the client, or a combination of the forgoing. Completed applications can then be printed on the printer and given to the individual employee's for their records.

In one embodiment, the system 200 further comprises a card production device 222 configured to store user information on the card 216. Thus, an employer or service provider can create and update custom identification cards for employees or other users. The custom identification cards can then be used to identify the employees, enroll the employees in employee benefits programs, or the like. Example card production devices include the P520 ID Card Printer or the Millennium 575× Full Color Badge Printer both available from Evolution ID Card Systems & Badge Supplies of Skokie, Ill., or the HDP600 High Definition Card Printer/Encoder available from Fargo Electronics, Inc. of Eden Prairie, Minn. An artisan will recognize from the disclosure herein that other card production devices can be used, including, devices that encode information on a radio frequency identification tag.

For example, an employee may swipe a driver's license through the card reader 212 to automatically populate a portion of an electronic enrollment form stored in the memory 224 of the computer 210. An enrollment facilitator may then assist the employee in inputting any additional information into the enrollment form. The employee can then sign the electronic signature pad 230 and a copy of the enrollment form can be generated by the printer 234 for the employee. Once the employee's information has been collected, at least a portion of the information can be used to create an employee identification card using the card production device 222. The employee identification card is configured to be read by the card reader 212 and can be used to automatically access the enrollment form or previously collected employee data, update previously collected employee data, populate additional enrollment forms, combinations of the forgoing, or the like.

In an exemplary embodiment, the card production device 222 is configured to code approximately one thousand characters onto an employee card. The characters can include personal and employee benefits information and may be formatted onto the card as illustrated in Table 1.

TABLE 1

| | APPROXIMATE NUMBER |
|---|---|
| DATA | OF CHARACTERS |
| Employer Name | 35 |
| Employee Name | 35 |
| Date of Birth | 8 |
| Sex | 1 |
| Social Security Number | 11 |
| Address | 50 |
| City | 20 |
| Zip Code | 5 |
| Home Phone | 12 |
| Email Address | 30 |
| Marital Status | 1 |
| Number of Dependents | 2 |
| Dependent Relation | 2 |
| Dependent Name | 35 |
| Dependent Date of Birth | 8 × 5 = 40 |
| Dependent Provider | 10 × 5 = 50 |
| Salary | 8 |
| Pay Period | 4 |
| Facility | 35 |
| Date of Hire | 8 |
| Title | 25 |
| Basic Insurance Benefit Plan | 400 |
| Insurance Provider Selections | 50 |

Thus, the card production device 222 provides a user card that can be customized to include a wide variety of information. The data and corresponding approximate number of characters shown in Table 1 is for exemplary purposes only and an artisan will recognize from the disclosure herein that not all of the data may be included or that different or additional data can be encoded onto the identification card. The card may also be formatted with title references such as a name header, a date of birth header, an address header, or the like. In the exemplary embodiment shown in Table 1, the title references comprise approximately 984 characters.

Employee cards generated by the card production device 222 allow employers to identify employees, speed up human resource related tasks, and quickly access an employee's benefit selections and personal details. Cards generated by the card production device 222 can also be used by insurance carriers and other related professionals such as doctor's offices, pharmacies, or the like to quickly look up benefits and rate information rather than accessing the information through web interfaces that can sometimes be cumbersome.

FIG. 2B is a block diagram of a system according to one embodiment for electronically filing an application. The system 250 comprises an application manager 252 configured to generate electronic applications and to transmit the applications to one or more servers 270, 272. The application manager 252 comprises a laptop 254, a card reader 256, a signature pad 258 and a printer/scanner device 260. Preferably, the application manager 252 is configured to download, scan, fill out, print, transmit, or otherwise process any type of application and is not limited to any specific type of industry or government application. Thus, the system 250 provides a user with the ability to automate application or form driven processes.

For example, the system 250 can be used by a fire inspector, termite inspector, or other type of inspector that fills out a form after completing an inspection and sends the form to one or more central locations. The inspector can load a portion of the form with information read from an I.D. card, complete the balance of information on the form, attach other documents to the form, sign the form, handle payment for the services, and transmit the completed forms as part of a case file to his regional office for processing. Other uses will occur to one of ordinary skill in the art including, for example, filling out and filing tax forms, forms to apply for government services, insurance forms, loan applications, or the like.

While the application manager 252 is shown in FIG. 2B as comprising separate components (i.e., discrete laptop 254, card reader 256, signature pad 258 and printer/scanner 260), an artisan will recognize from the disclosure herein that one or more of the components can be combined. For example, in one embodiment the laptop 256 may comprise a screen 262 usable to display data and to function as a signature pad. Similarly, the laptop 254 may include an internal card reader, printer, scanner, or a combination of the forgoing. An artisan will also recognize from the disclosure herein that the laptop 254 may comprise any conventional computer including, for example, a desktop computer, a miniature computer, a personal digital assistant, or the like. Further, the printer/scanner 260 device 260 may be two separate components (i.e., a discrete printer and a discrete scanner).

In one embodiment, the application manager 252 is relatively transportable and small as compared to a conventional desktop computer attached to an office printer and scanner. Thus, the application manager 252 can be easily taken from one location to another or from job site to job site.

The card reader 256 is configured to read information from a user identification device such as a driver's license or other government identification card, an employee identification card, other identification cards, a radio frequency identification tag, combinations of the forgoing, or the like. In one embodiment, the card reader 256 is configured to read a barcode and a magnetic stripe on an identification card. Preferably, the identification card comprises data to identify a cardholder including, for example, name, address, other contact information, or the like.

The identification card can include information that is usable to fill out a specific form or information that is usable to fill out any type of form. The identification card may also include header information to identify portions of the data thereon. For example, the identification card may include headers to identify name, address, date of birth, gender, employer, employer address, user identification number, or other information that can be inserted into an location in an application.

The laptop is configured to populate an application with information read by the card reader. Additional information may also be entered into the application manually through, for example, a keypad or mouse. In addition to gathering data to enter into applications, the card reader 256 is also usable for billing purposes. For example, a user can swipe a credit card, debit card, or the like through the card reader 256 and an authorizing signature can be entered into the signature pad 258 or a personal identification number (PIN) can be entered into the laptop 262 to authorize the payment transaction. The printer/scanner device 260 can print a receipt that can be given to the user as proof of payment.

The electronic signature pad 258 can also be used to electronically sign the application. Additional documents, if any, required by the application can be scanned by the printer/scanner device 260 and electronically attached to the application. Once the application is complete, the printer/scanner device 260 can print a copy of the application for the user. The application can then be sent electronically to a server 270, 272 for processing. The application can be sent through a connection 274 to the server 270 through, for example, a direct wire connection or dial-up connection. The application can also be sent through the Internet 278 or other computer network to the server 272. The application can also be sent to one or more of the servers 270, 272 through a wireless connection 280 such as a wireless radio network, a wireless Internet connection, a Wi-Fi (IEEE 802.11) network connection, or the like.

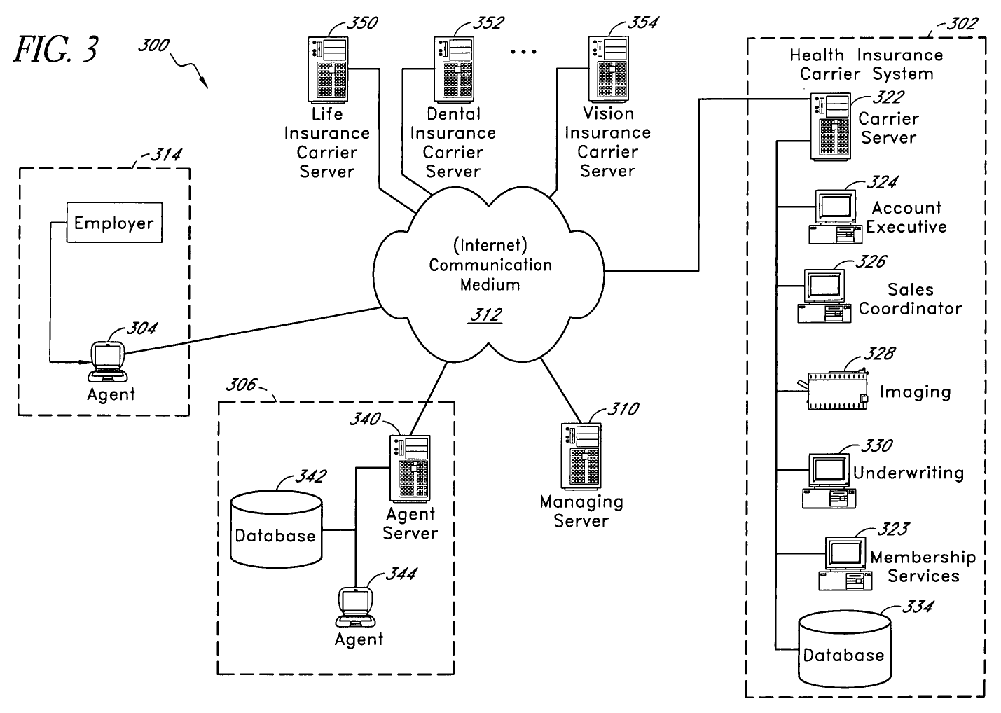

FIG. 3 is a block diagram of a system 300 according to one embodiment for registering one or more individuals for products or services offered by one or more providers. For illustrative purposes, the system 300 is discussed herein in relation to enrolling employees in one or more employee benefit programs such as life insurance, disability insurance, medical insurance, dental insurance, other types of health insurance, financial planning services, retirement benefit services, combinations of the forgoing, or the like. However, an artisan will recognize from the disclosure herein that the system 300 can be configured to register users, either individually or as one or more user groups, for any type of products or services.

Thus, in this example, the system 300 is configured to generate, process and transfer data between the entities involved in an employee benefits transaction. The system 300 includes a health insurance carrier system 302 comprising a carrier enrollment module (not shown), an agent/broker module 304 comprising an enrollment module (not shown), a general agent system 306 comprising an enrollment module (not shown), a managing or authentication server 310 comprising an interface module (not shown) coupled through a communication medium 312. The system 300 also includes a life insurance carrier server 350, a dental insurance carrier server 352, and a vision insurance carrier server 354.

As discussed in detail below, an insurance broker or agent uses the agent/broker module 304 to enroll employees of a company in benefits programs. In this example, the agent sells health, life, dental, and vision insurance to the company and goes to a company facility 314 to register the company and the employees for these group benefits. The agent fills out electronic group and individual employee applications in the agent/broker module 304 and transmits the electronic applications to respective providers. For example, health insurance applications are transmitted to the health insurance carrier system 302, life insurance applications are transmitted to the life insurance carrier server 350, dental insurance applications are transmitted to the dental insurance carrier 352, and vision insurance applications are transmitted to the vision insurance carrier 354.

The managing or authentication server 310 is configured to coordinate transactions between the agent/broker module 304, the health insurance carrier system 302, the life insurance carrier server 350, the dental insurance carrier server 352, and the vision insurance carrier server 354. For example, in one embodiment the agent/broker module 304 is operated by an independent broker who may sell health insurance not only for a service provider that operates the health insurance carrier system 302, but also for one or more other service providers (not shown) of health insurance. The managing or authentication server 310 is operated by a third party and comprises a website configured to provide forms to the broker that can be used for health care service providers that participate in electronic application transactions coordinated by the managing or authentication server 310. Thus, the broker can select a service provider listed on the website to automatically send electronic applications to that provider in a format that will be recognized by the service provider.

In one embodiment, the managing or authentication server 310 also coordinates requests for information sent between the agent/broker module 304 and the service providers. The managing or authentication server 310 verifies the identity of the broker and the service providers when the messages are sent. Thus, the broker can participate in the transaction without knowing a URL for each service provider and without providing a separate password or verification procedure for each service provider. An artisan will recognize from the disclosure herein that in an embodiment a service provider such as the health insurance carrier system 302 can operate the managing or authentication server 310. In such an embodiment, agents employed by the health insurance carrier system 302 can access a website configured to provide the services described above. In other embodiments, brokers can directly access one or more of the health insurance carrier system 302, the life insurance carrier server 350, the dental insurance carrier server 352, and the vision insurance carrier server 354, without the managing or authentication server 310.

As used herein, the word module is a broad term that has its ordinary and customary meaning and also may include in the alternative logic embodied in hardware or firmware, or to a collection of software instructions (i.e., a software module), possibly having entry and exit points, written in a programming language, such as, for example, C or C++. Such a software module may be compiled and linked into an executable program, installed in a dynamic link library, or may be written in an interpreted programming language such as BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

The communication medium 312 can include, for example, a local area network (LAN), a wide area network (WAN), the Internet, or other connection services and network variations such as the world wide web, the public internet, a private intranet, a private computer network, a secure internet, a private network, a public network, a value-added network, a wireless radio network, wireless Internet connections, Wi-Fi (IEEE 802.11) network connections, combinations of the foregoing, or the like.

The health insurance carrier system 302, agent/broker module 304, general agent system 306, and managing or authentication server 310 can include, for example, computers comprising any microprocessor controlled device that permits access to the communication medium 312, including terminal devices, such as personal computers, workstations, servers, mini-computers, hand-held computers, main-frame computers, laptop computers, mobile computers, set top boxes for televisions, combinations thereof, or the like. The computers may further include input devices such as a keyboard or a mouse, and output devices such as a computer screen, a printer or a speaker.

The health insurance carrier system 302 includes a carrier server 322, an account executive subsystem 324, a sales coordinator subsystem 326, an imaging subsystem 328, an underwriting subsystem 330, a membership services subsystem 332, and a database 334 connected through a LAN 336. The general agent system 306 comprises a general agent server 340, a database 342 and an agent workstation 344. An artisan will recognize from the disclosure herein that the system 300 may comprise one or more carrier servers in addition to the life insurance carrier server 350, the dental insurance carrier server 352, and the vision insurance carrier server 354. For example, the system 300 may comprise a disability insurance carrier server or a server operated by another service provider. An artisan will recognize that the servers 322, 340, 350, 352, 354, databases 334, 342, work station 344, and subsystems 324, 326, 328, 330, 332 can be implemented on one or more computers. These computers may be single-processor or multiprocessor machines.

As discussed below, the carrier servers 322, 350, 352, 354 and agent server 340 are configured to process enrollment data collected by the agent/broker module 304, the general agent system 306, or both. The managing or authentication server 310 hosts one or more user interfaces, such as web pages or the like, for managing employee benefit enrollment processes and sending information back and forth between the agent/broker module 304, general agent system 306 and the carrier servers 322, 350, 352, 354. For example, the managing or authentication server 310 may host a website accessible by the agent/broker module 304, the general agent system 306 through the communication medium 312. By logging into the website, the agent/broker module 304 or the general agent system 306 can access, upload, download, or directly update enrollment data managed by one or more of the carrier servers 322, 350, 352, 354.

Portions of the agent/broker module 304 and the general agent system 306 may be portable so as to be transported to an employer's site 314 and used to enroll the employer's employees in one or more employee benefit programs. For example, in one embodiment one or more of the agent/broker module 304 and the general agent system 306 comprise an application manager such as the application manager 252 discussed above in relation to FIG. 2B. In this example, a broker or carrier representative transports the agent/broker module 304 to the employer's site 314 for group enrollment meetings.

In one embodiment, the agent/broker module 304 is configured to download the data from an online ASP. In addition, or in other embodiments, portions of the data are entered manually into the agent/broker module 304. In certain embodiments, the agent/broker module 304 is configured to automatically enter data by, for example, reading an identification card such as a driver's license or a state issued identification card as described above in relation to FIG. 2A.

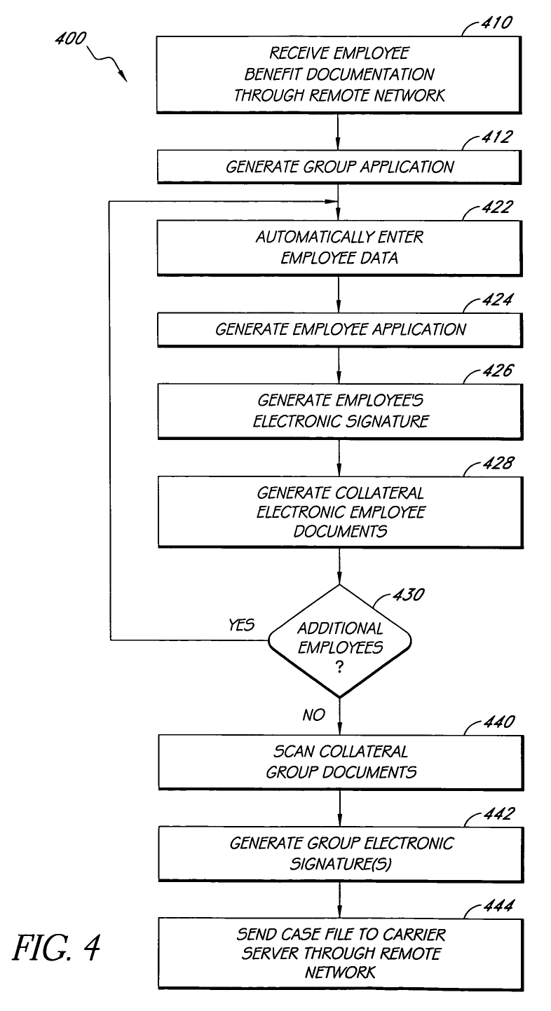

The enrollment modules in the agent/broker module 304 and the general agent system 306 are configured to register employees for employee benefit programs. Independent brokers or carrier representatives, for example, may operate the agent/broker module 304 and the general agent system 306. FIG. 4 is an exemplary flow chart illustrating portions of an enrollment process 400 according to one embodiment usable by an enrollment module in the agent/broker module 304 shown in FIG. 3.

Referring to FIGS. 3 and 4, an agent may sell one or more employee benefit plans to the employer. Once the employee benefit plans are sold, the agent can transport the agent/broker module 304 to the employer site 314 to conduct enrollment meetings. In a block 410, the enrollment module in the agent/broker module 304 receives employee benefit documentation through a remote network such as the communication medium 312. The employee benefit documentation may include descriptions of the benefit plans, group application forms and employee application forms. The employee benefit documentation may further include provider listings such as participating professionals in medical groups, pharmacy groups, or the like.

In a block 412, the agent/broker module 304 generates an electronic group application. In one embodiment, group information is entered into the agent/broker module 304 and used to populate one or more group applications. The group information may be used to complete separate group applications for each employee benefit plan such as a medical, dental, life, and vision insurance plan, or the like.

In one embodiment, at least a portion of the group information is downloaded from the employer. An artisan will recognize from the disclosure herein that downloading information from the employer may comprise, for example, providing a communication link between the agent/broker module 304 and the employer and transferring files through the link using a file transfer protocol. An artisan will also recognize that downloading information from the employer may comprise, for example, saving the information onto a removable storage medium such as a compact disk (CD), digital versatile disk (DVD), floppy disk, or the like and copying the information from the removable storage medium onto the agent/broker module 304. In some embodiments, the information is downloaded from an online ASP or from one or more of the servers 322, 340, 350, 352, 354.

Downloading group information to automatically populate the group applications saves time and increases the accuracy and consistency of the data of the group applications. In addition, or in other embodiments, the group information is entered manually. For example, a portion of the group information may be downloaded from the employer as discussed above and additional information, such as information not possessed by the employer, may be keyed-in manually. In one embodiment, the group information comprises an employer name, an employer address, a number of employees, a carrier selected to administrate the plan, and an agent name. In some embodiments, the group information further includes payroll (DE6) information, current carrier billing information, and plan specific data.

After collecting the group information, the agent/broker module 304 enrolls each participating employee in one or more employee benefit plan offerings. In a block 422, the agent/broker module 304 automatically enters employee data by reading an employee's driver's license or state issued identification card. As described above, a portion of the employee data is downloaded from the employer or an online ASP. For example, in one embodiment, the agent/broker module 304 reads a state issued identification card to acquire basic employee information such as an employee name and identification number. Additional employee data not included in the agent/broker module 304 is entered manually. In one embodiment, the employee data includes an employee name, birth date, gender, and a resident address. In some embodiments, the employee information further includes dependent information, benefit plan options, and other personal information as discussed above.

In block 424, the agent/broker module 304 generates an electronic employee application. A portion of the employee data is used to automatically fill in the employee application. A portion of the employee application may also be automatically populated with data from the group application or from another electronic source. For example, in one embodiment, the agent/broker module 304 is configured to display a list of participating providers such as doctors, medical groups, or the like. A user selection from the displayed list can be automatically included in the employee application. A portion of the employee application may also be filled in manually. Preferably, however, the agent/broker module 304 is configured to automatically generate the employee application using stored data such that manual data entry is reduced during enrollment.

In block 426, the agent/broker module 304 generates the employee's electronic signature using, for example, an electronic signature pad. The electronic signature can be included as part of the employee application to show, for example, that the employee has reviewed the accuracy of the data and approves of the options selected. In a block 428, the agent/broker module 304 generates collateral electronic employee documents to include with the employee application. The collateral electronic employee documents may include, for example, additional forms or documents required by the carrier, dependency information, payroll records (DE6), combinations of the forgoing, or the like. The collateral electronic employee documents may be generated by automatically populating additional electronic forms, scanning hard copies of the documents, combinations of the forgoing, or the like. Once the employee application is complete, a copy can be printed for the employee's records.

In block 430, the process 400 queries whether there are additional employees to generate employee applications for. If there are additional employees, the process 400 returns to the block 422. If there are not additional employees, the process 400 proceeds to block 440 where the agent/broker module 304 scans collateral group documents to include with the group application. The collateral group documents may include, for example, additional forms or documents required by the carrier, payroll records (DE6), copy of current carrier billing, combinations of the forgoing, or the like. The collateral group documents may also be generated by automatically populating additional electronic forms by reading identification cards, or downloading data from the employer as described above.

In block 442, the agent/broker module 304 generates group electronic signatures comprising, for example, the authorized signature of the employer, the signature of the agent, other signatures required by the carrier, combinations of the forgoing, or the like. The group electronic signatures may be generated, for example, by an electronic signature pad. In one embodiment, verified electronic signatures are used in which the signer's identity and authorization are verified by an independent third party.

In block 444, the agent/broker module 304 sends case files to one or more of the carrier servers 322, 350, 352, 354 through the remote network (i.e., through the communication medium 312) for processing. The case files comprise the group applications, the employee applications and the collateral documents. By way of example, and not by limitation, the agent/broker module 304 may send a health insurance data file to the health insurance carrier server 322, a dental insurance data file to the dental insurance carrier 350, a life insurance data file to the life insurance carrier server 352, and a vision insurance data file to the vision insurance carrier server 354. In some embodiments, the agent/broker module 304 also sends case files to the general agent server 340 for processing or storage in the database 342.

To send an electronic case file to one of the carrier servers 322, 350, 352, 354 the agent/broker module 304 logs into an interface such as a website or the like hosted by the managing or authentication server 310. The agent/broker module 304 then selects one of the carrier servers 322, 350, 352, 354 to send the case file to, and transmits the case file to the selected carrier server 322, 350, 352, or 354 through the communication medium 312. Preferably, the case file is sent via a secure socket layer (SSL) connection which provides an encrypted data tunnel to the selected carrier server 322, 350, 352, or 354 in compliance with HIPAA regulations or the like. The system 300 preferably includes other HIPAA compliant features including, for example, unique user identifications, emergency access procedures, automatic logoff procedures, user session time-out, data encryption, or the like.

The managing or authentication server 310 comprises an annotation system (not shown) configured to allow users such as the agent/broker module 304, the general agent system 306, and the carrier servers 322, 350, 352, 354 to request and exchange information related to the case file. If, for example, the case file is sent to the carrier server 322, data in the carrier server 322 is updated with information from the case file and any communications logged through the annotation system are made available to the health insurance carrier system 302. Further, if information in the case file is incomplete or inaccurate, one of the subsystems 324, 326, 328, 330, 332 can send a message through the annotation system to the agent/broker module 304. The agent/broker module 304 can access the message the next time it logs onto the managing or authentication server 310 and downloads the case file.

The carrier server 322 assigns a case management number and a routing number to the case file. The case management number is electronically stamped onto the documents in the case file to associate the documents with the case file. The routing number is used to identify and align case file workflow among the various subsystems 324, 326, 328, 330, 332. In one embodiment, case files are routed and queued in the subsystems 324, 326, 328, 330, 332 on a first-come-first-served basis.

Users of the subsystems 324, 326, 328, 330, 332 of the health insurance carrier system 302 process the case file by, for example, reviewing the case file data on the carrier server 322, scrubbing the case file for accuracy by comparing the case file to existing data in the database 334, requesting additional or corrected data through the annotation system, updating the case file, combinations of the forgoing, or the like. When the case file has been updated, the agent/broker module 304 is alerted through the managing or authentication server 310 or by e-mail. The agent/broker module 304 can then download the updated case file, respond to any requests and send the case file back to the carrier server 322. Once the case file is completed at the health insurance carrier system 302, the underwriting subsystem 330 sends validated rates back to the agent/broker module 304 through the managing or authentication server 310 and updates associated data related to individual employee enrollments. The underwriting subsystem 330 also sends the case file to the membership services subsystem 332 where it is entered into the database 334 and an account is established.

In one embodiment, the membership services subsystem 334 sets up an electronic deposit transfer account through the managing or authentication server 310 or another website to automatically deduct billed amounts from the employer's bank account. This reduces the need for a paper transaction in the form of a check or the like. The agent/broker module 304 sets up such an online electronic deposit transfer account by submitting an electronic check authorization that can be validated through an online merchant account. In another embodiment, the agent/broker module 304 sets up automatic billing to the employer.

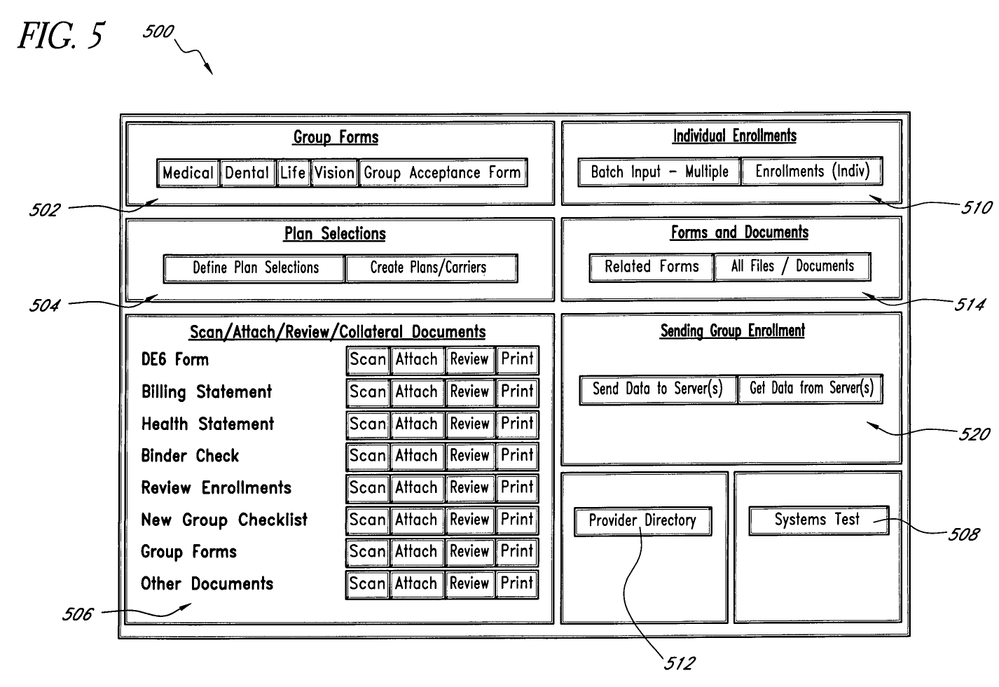

FIG. 5 generally illustrates an example of a user interface 500 that is usable by the agent/broker module 304, the general agent system 306, or the managing and authentication server 310, to register individuals or groups for a product or service offered by a provider according to one embodiment of the invention. In a preferred embodiment, the user interface 500 is stored on the agent/broker module 304 shown in FIG. 3. In other embodiments, the user interface 500 is stored on the managing or authentication server 310 and is accessible to the agent/broker module 304 through the communication medium 312. The user interface 500 allows a user to select and complete one or more electronic group forms by selecting one or more group form buttons 502. The electronic group forms include, for example, medical insurance forms, dental insurance forms, life insurance forms, vision plan forms, group acceptance forms, or the like.

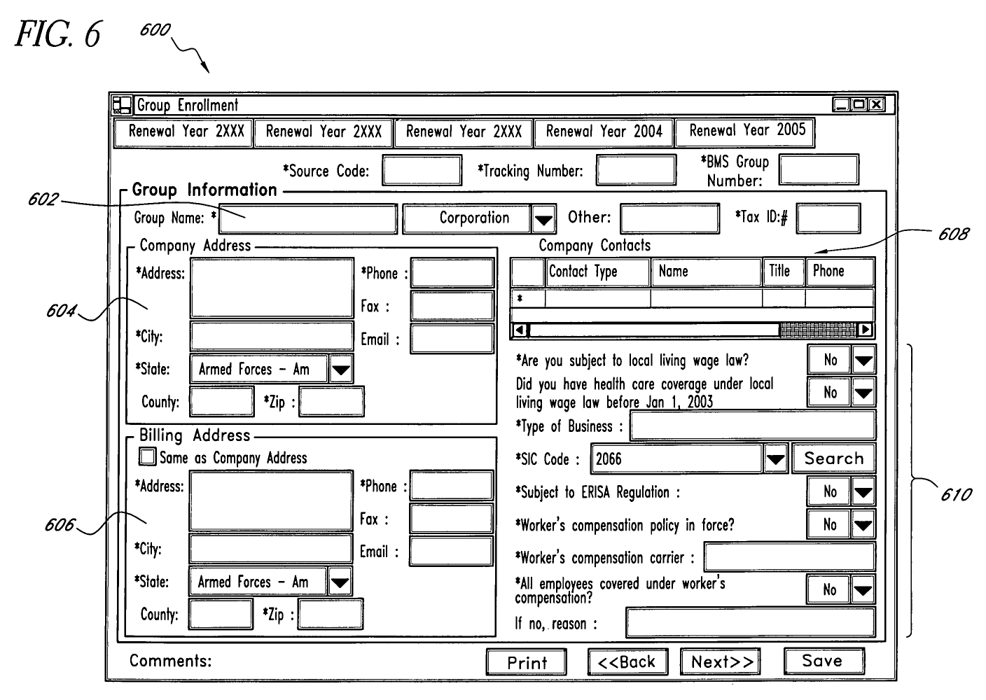

FIG. 6 generally illustrates an example of an electronic group form 600 according to an embodiment of the invention. The electronic group form 600 comprises data entry fields for entering a variety of information related to the group including a group name field 602, company address fields 604, billing address fields 606, company contact fields 608 and government regulation information. In some embodiments, the electronic group form 600 includes additional data entry fields such as current carrier information, number of employees, employee contribution percentage, employee eligibility data, plan options, agent information, medical questionnaire, combinations of the forgoing, or the like.

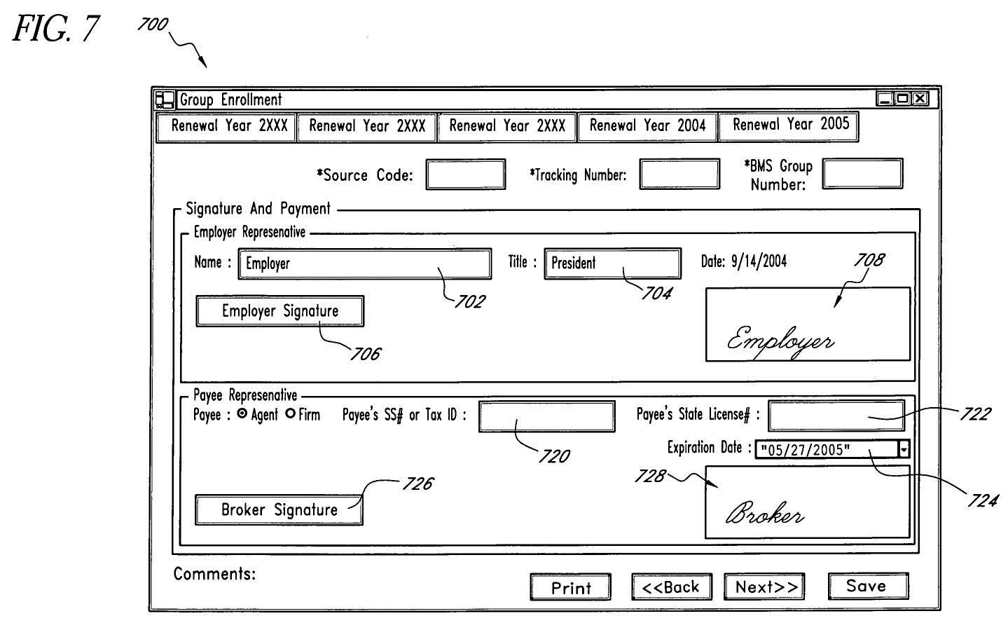

Once the electronic group form 600 has been filled out, an authorized employer representative and a broker can sign the electronic group form 600 using, for example, an electronic signature pad. For example, FIG. 7 illustrates a user interface 700 that is usable to sign the electronic group form 600. The user interface 700 includes a data entry field for entering the employer representative's name and a data entry field 704 for entering the employer representative's title. Upon selecting an employer signature button 706, the employer representative is prompted to sign an electronic signature pad and a resulting image 708 of the signature is displayed in the user interface 700. If the information in the electronic group form 600 is changed after the employer representative's signature has been entered into the user interface 700, the employer representative's signature will be removed from the user interface 700. When the updated electronic group form 600 is saved, the user interface 700 will prompt the employer representative to re-sign the electronic group form 600 using the signature pad.

The user interface also includes a data entry field 720 for entering the broker's social security number or tax identification number, a data entry field 722 for entering the broker's state license number, and a data entry field 724 to enter the expiration data of the state license. Upon selecting a broker signature button, the broker is prompted to sign an electronic signature pad and a resulting image 728 of the signature is displayed in the user interface 700.

Returning to FIG. 5, the user interface 500 also allows a user to enter plan selections by selecting one or more plan selection buttons 504. Thus, the user can define one or more employer facilities and create rules that associate carrier plans and benefit levels to the facilities. The user can also enter new benefit plans or enter information for new carriers. The user can define plan selections based at least in part on carrier preference. Thus, the user interface 500 allows the enrollment system to expand and creates control over the enrollment process.

The user interface 500 also includes buttons 506 to scan, attach, review or print collateral documents relative to the group enrollment. Such collateral documents include, for example, DE6 forms, billing statements, health statements, binder checks, review enrollment forms, new group checklists, group forms, other documents, or the like.

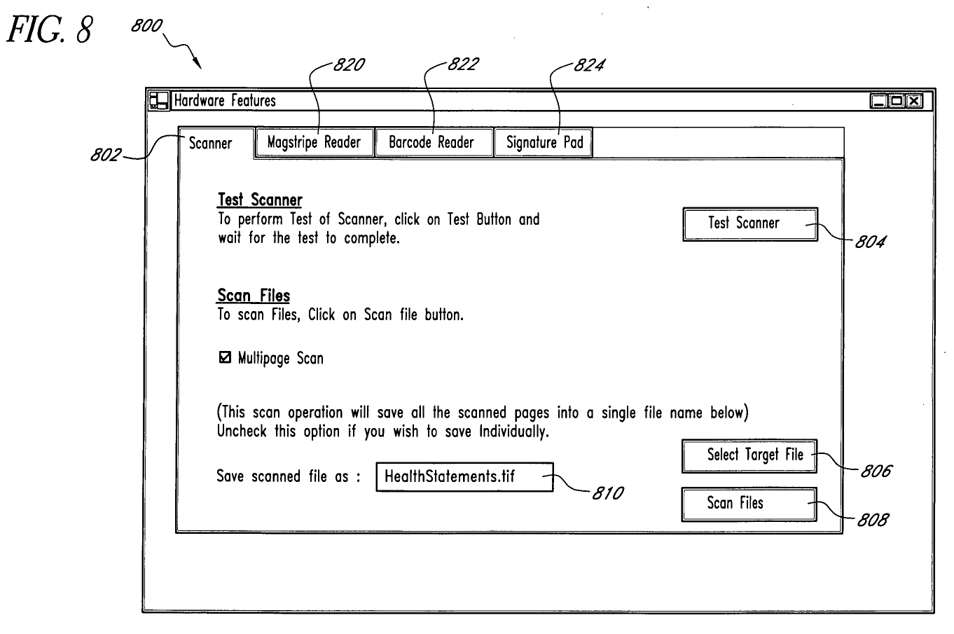

The user interface 500 includes a system test button 508 configured to test or operate peripheral devices attached to an enrollment system. When the system test button 508 is selected, a user interface such as that shown in FIG. 8 is displayed to the user. FIG. 8 illustrates an exemplary user interface 800 for testing and controlling peripheral hardware devices. The user interface 800 includes a scanner tab 802 configured to control a scanner for generating images of hardcopy documents. The scanner tab 802 includes a button 804 configured to automatically test the scanner. The scanner tab 802 also includes a button 806 for specifying a file where the scanned image will be stored when a scan files button 808 is selected. The file name is displayed in a field 810.

The user interface 800 also includes a tab 820 for testing and controlling a magnetic stripe reader, a tab 822 for testing and controlling a barcode reader, and a tab 824 for testing and controlling an electronic signature tab 824. An artisan will recognize from the disclosure herein that other peripheral devices can also be tested or otherwise controlled by the user interface 800.

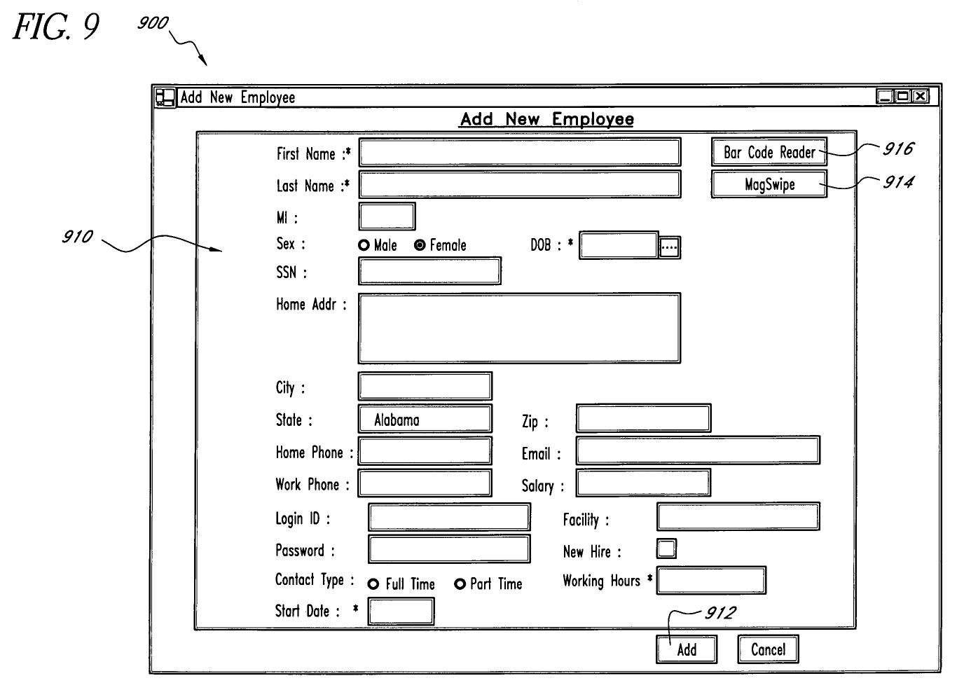

The user interface 500 also includes buttons 510 to input individual employee data or to use batch files or the like to upload multiple records into the enrollment system or to fill out employee enrollment forms. The employee data can be entered manually, automatically, or both. FIG. 9 illustrates an exemplary user interface 900 for manually or automatically entering employee data. The user interface 900 includes data entry fields 910 for entering employee data. The data entry fields 910 can be filled in manually with the appropriate information and entered into the system by selecting a button 912. In addition, or alternatively, selecting a button 914 to read a magnetic stripe or a button 916 to read a barcode can fill in at least a portion of the data entry fields 910.

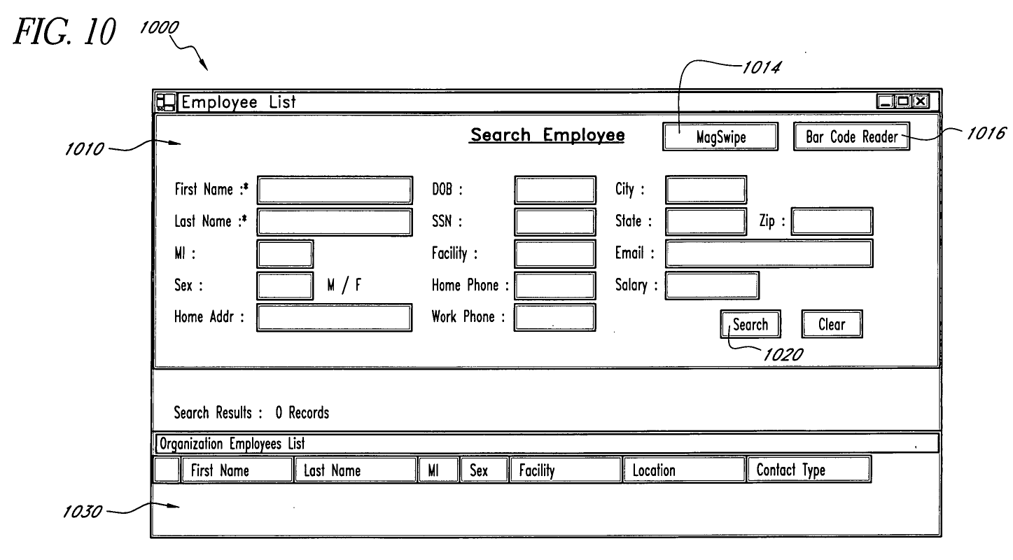

FIG. 10 illustrates an exemplary user interface 1000 that is usable to search for and modify employee data. Upon pressing a search button 1020, search parameters entered in one or more data fields 1010 are used to identify employee records. Employee records that match the search parameters are displayed in a portion 1030 of the user interface 1000 and can be individually selected to update the data therein. The search parameters can be entered into the data fields 1010 manually or automatically by selecting a button 1014 to read a magnetic stripe or a button 1016 to read a barcode.

Once the employee data has been entered into the user interface 900 or modified in the user interface 1000, the employee selects one or more of a medical, dental, life, or vision insurance plan as part of a benefit offering made available through the employer. For each plan selected, an electronic enrollment application is automatically populated with the employee information in the user interface 1000 and is completed with the balance of information that is required by the insurance carrier to enroll the employee and any dependents of the employee in the insurance plan.

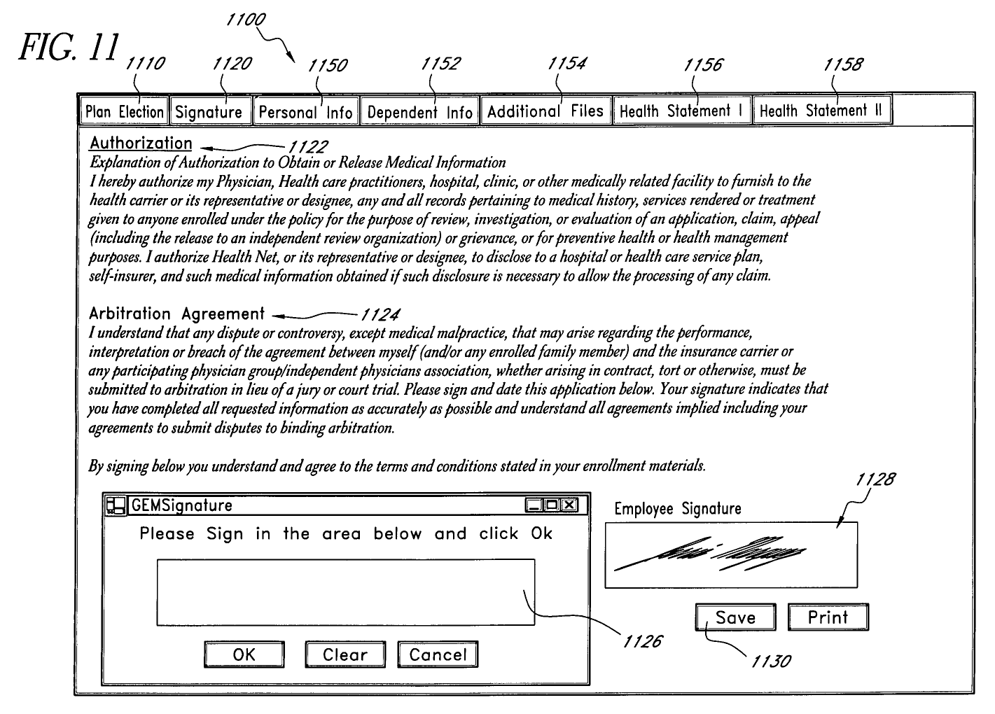

When the electronic enrollment application is complete, the employee verifies the application's accuracy, reads any contractual language associated with the application, and electronically signs the application using an electronic signature pad. FIG. 11 illustrates an exemplary user interface 1100 that is usable by the employee to review, modify and sign the electronic enrollment application. The user interface 1100 comprises a plan election tab 1110, a signature tab 1120, a personal info tab 1150, a dependent info tab 1152, an additional files tab 1154, and health statement tabs 1156, 1158.

In one embodiment, the signature tab 1120 displays authorization contractual language 1122 and arbitration agreement contractual language 1124 that the employee agrees to by signing the electronic enrollment application. In other embodiments, other consent or informational language provided by the insurance carrier to the employee can be displayed. Once the employee has verified that the information in the tabs 1110, 1120, 1150, 1152, 1154, 1156, 1158 is correct, the employee signs the electronic enrollment application in a signature window 1126 using an electronic signature pad. An image of the signature 1128 then appears in the signature tab 1120.

The signature window 1126 is displayed when a signature button (not shown) is selected. The signature window 1126 is also displayed when a save button 1130 is selected and the data in the electronic enrollment application has changed since the employee last signed the electronic enrollment application. For example, the employee may sign the electronic enrollment application without providing all of the required information or may later discover that a portion of the information is incorrect. When the information is corrected or when new information is added, the image of the signature 1128 is no longer displayed in the signature tab 1122. When the employee (or an agent or broker assisting the employee) saves the changes by pressing the save button 1130, the signature window 1126 is displayed to prompt the employee to re-sign the electronic enrollment application. In one embodiment, the save button 1130 is displayed in each tab 1110, 1120, 1150, 1152, 1154, 1156, 1158.

Returning to FIG. 5, the user interface 500 also allows a user such as an employee to view and select participating providers such as doctors, medical groups, pharmacy groups, or the like by selecting a provider directory button 512. The provider directory may be accessible online or locally. The provider directory can be sorted by name, city, zip code or other criteria including user preference and allows an employee to directly make provider selections in the enrollment system.

The user interface 500 further includes buttons 514 to view, print, fill-out and organize forms and other documents related to the enrollment process. For example, a user may find, print, and fill out an electronic form or other document provided by a carrier. The document can then be printed, signed, scanned into the system and attached as part of the electronic group file. As described above, the user can upload or download the group file from one or more agent or carrier servers by selecting one or more buttons 520 on the user interface 500.

Based on the foregoing, an example operation of a system for enrolling employees will now be described. In this example, a service provider such as an insurance carrier offers an employee benefit plan sold by a broker. The broker sells the employee benefit plan to a company. The broker then goes to one or more facilities of the company to enroll its employees in the employee benefit plan.

To enroll the employees, the broker accesses electronic forms through a computer. In one embodiment, the electronic forms are stored on the computer. In another embodiment, the electronic forms are stored on a remote computer and the broker access the forms through a website operated by a third party. Alternatively, the service provider operates the website.

The broker fills in the electronic forms by entering data into the computer. The computer comprises peripheral devices to assist in the entry of data. In one embodiment, the peripheral devices include a card reader and an electronic signature pad. To enter data for a particular employee, the employee swipes an identification card such as a driver's license or state issued identification card through the card reader. The card reader sends employee information encoded on the identification card to the computer. The employee information includes header information used to sort the employee information among data entry fields in an employee application. Thus, a portion of the application is filled in automatically. Other data entry fields that correspond to information not encoded on the identification card can be filled in manually.

In one embodiment, at least some of the data entry fields in the employee application are filled in from information obtained from the company. For example, the employee may swipe the state issued identification card as part of a search process wherein data from the card is used to identify the employee and search for additional information corresponding to the employee in databases operated by the company. The additional information is then used to fill in the form. The card reader can also be used to read a credit card or a debit card.

In one embodiment, the peripheral devices include a printer and a scanner configured to operate as described above.

Once the electronic application has been filled out, the employee can sign the electronic signature pad to insert an image of the signature into the application. In one embodiment, a third party authenticates the electronic signature.

When all of the electronic applications corresponding to the employee benefit plan sold by the broker have been filled out, they are sent to the service provider through a computer network. If necessary, the provider then requests additional information from the broker. If the electronic applications are correct and meet guidelines of the service provider, the service provider would also notify the broker that the applications are approved.

The attached Appendix forms a part of this patent application and describes a group enrollment module in accordance with the invention. It should be recognized that the attached Appendix is not meant to limit the scope of the invention.

While certain embodiments of the inventions have been described, these embodiments have been presented by way of example only, and are not intended to limit the scope of the inventions. The novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A method of obtaining products or services offered by a remote provider, the method comprising:
displaying an application form in response to selection of a desired product or service;
reading user data into a computer from an identification card;
automatically entering the user data into appropriate data entry fields of the application form;
completing the application form; and
communicating the completed application form to a remote server configured to create a user account in response to receiving the application form.

2. The method of claim 1, wherein reading the user data comprises extracting information encoded on a driver's license.

3. The method of claim 1, wherein reading the user data comprises extracting information encoded on the identification card.

4. The method of claim 1, wherein completing the application form comprises manually keying additional information into appropriate data entry fields of the application form.

5. The method of claim 1, further comprising generating one or more collateral documents associated with the application form.

6. The method of claim 5, wherein generating the one or more collateral documents comprises scanning a hard copy document into the computer.

7. The method of claim 5, further comprising communicating the one or more collateral documents to the remote server with the application form.

8. The method of claim 1, further comprising entering an electronic signature into the computer and associating the electronic signature with the application form.

9. The method of claim 1, further comprising receiving a request from the remote server to update the application form.

10. A system for enrolling customers for services offered by insurance carriers, the system comprising:
an agent system comprising an enrollment module configured to display an enrollment form, wherein the enrollment module is configured to populate user data into appropriate data entry fields of the enrollment form;
one or more carrier servers comprising carrier modules configured to receive the enrollment form from the enrollment module through a computer network; and
a managing server comprising an interface module that coordinates communication between the enrollment module and the carrier modules, wherein the one or more carrier servers are listed in the interface module, and wherein the enrollment module is configured to selectively send the enrollment form to the one or more carrier servers listed on the interface module.

11. The system of claim 10, wherein the interface module comprises a web page.

12. The system of claim 10, further comprising:
a card reader;
an electronic signature pad;
a scanner; and
a printer.

13. The system of claim 12, wherein the card reader is configured to read the user data from an identification card that is encoded in one or more of:
a barcode;
a magnetic stripe; and
a radio frequency identification tag.

14. The system of claim 12, wherein the enrollment module is configured to associate an electronic signature from the electronic signature pad with the enrollment form.

15. The system of claim 12, wherein the enrollment module is configured to associate an image from the scanner with the enrollment form.

16. The system of claim 15, wherein the image corresponds to one or more of:
an insurance form;
a tax form;
a billing statement;
a health statement;
a check; and
a checklist.

17. The system of claim 10, wherein the enrollment form is configured to enroll employees in an employee benefit program for one or more of:
medical insurance;
dental insurance;
vision insurance;
life insurance; and
disability insurance.

18. The system of claim 17, wherein the enrollment form comprises one or more of:
a group enrollment form;
an employee enrollment form; and
a group acceptance form.

19. The system of claim 10, wherein the carrier modules are further configured to:
scrub the enrollment form;
request updates to the enrollment form from the enrollment module; and
allow the user to approve the enrollment form.

20. A method for enrolling customers for services offered by employee benefit providers, the method comprising:
providing a web page to a broker, the web page listing employee benefit providers;
providing an electronic application to the broker, the electronic application comprising data entry fields for information sufficient to enroll an individual in services provided by at least one of the employee benefit providers listed on the web page;
receiving a processed electronic application from the broker; and
transmitting the processed electronic application to an employee benefit provider selected by the broker from the list on the web page.

21. The method of claim 20, wherein providing the electronic application to the broker comprises transmitting the electronic application to an agent system operated by the broker from the web page, wherein the broker uses the agent system to populate data from an identification card into the data entry fields.

22. The method of claim 20, further comprising providing the web page to the employee benefit providers listed thereon.

23. The method of claim 22, further comprising routing messages between the broker and the employee benefit providers through the web page.

24. A method for enrolling a group of users in an employee benefit program, the method comprising:
generating an electronic group application;
reading data from an identification card into a computer system;
automatically populating the data into corresponding data entry fields in an employee application;
generating a case file comprising the group application and the employee application; and
sending the case file to a server through a computer network.

25. The method of claim 24, further comprising inserting an image of a signature into the group application.

26. The method of claim 24, further comprising inserting an image of a signature into the employee application.

27. The method of claim 24, further comprising:
generating an image of a hard copy document; and
including the image in the case file.

28. The method of claim 27, further comprising associating the image with the group application in the case file.

29. The method of claim 27, further comprising associating the image with the employee application in the case file.

30. The method of claim 24, further comprising receiving employee benefit documentation from the server through the computer network.

31. The method of claim 24, further comprising:
receiving a request from the server to modify the case file;
in response to the request, modifying the case file; and
sending the modified case file to the server through the computer network.

32. A portable system for processing an application, the system comprising:
a computer;
a card reader configured to read data from an identification card into the computer; wherein the computer is configured to populate an application with the data;
a signature pad configured to generate a first image of writing written thereon, wherein the computer is configured to associate the first image with the application; and
a communication device configured to transmit the application to a remote server.

33. The portable system of claim 32, wherein the computer, card reader, signature pad, and communication device are sized and configured to be transported to a remote location.

34. The system of claim 32, wherein the first image is transmitted with the application.

35. The system of claim 32, wherein the card reader is further configured to read payment information into the computer.

36. The system of claim 35, further comprising a printer configured to print a receipt corresponding to the payment information.

37. The system of claim 32, further comprising a printer configured to print the application.

38. The system of claim 32, further comprising a scanner configured to generate a second image of a document, wherein the computer is configured to associate the second image with the application.

39. The system of claim 38, wherein the second image is transmitted with the application.
